(19) United States
(12) Patent Application Publication
(10) Pub. No.: US 2009/0096869 A1
(43) Pub. Date: Apr. 16, 2009

(54) MOTOR BACKING-UP MONITORING DEVICE

(76) Inventor: Yao-Hung HUANG, Jen Te Hsiang (TW)

Correspondence Address: SINORICA, LLC, 528 FALLSGROVE DRIVE, ROCKVILLE, MD, 20850, US

(21) Appl. No.: 11/872,602

(22) Filed: Oct. 15, 2007

(51) Int. Cl. H04N 7/18; H04B 7/00

(52) U.S. Cl. 348/148; 455/41.2; 348/E07.085

(57) ABSTRACT

A motor backing-up monitoring device includes a main body, an emitting device, a transmitting device, a receiving device and a displaying device. The main body is formed similarly as a hollow shell, having a power source connector at its one side and a lens connected at the other side. The emitting device is connected with the lens to transmit the images shot by the lens to the transmitting device, the receiving device and the displaying device orderly. Seeing from the displaying device to totally realize the situation behind a vehicle, a driver can easily and securely back up the vehicle.

### BACKGROUND OF THE INVENTION

1. Field of the Invention

This invention relates to a motor backing-up monitoring device, particularly to one able to display images behind a vehicle on a screen to let the driver back up easily and securely.

2. Description of the Prior Art

Commonly, a conventional motor backing-up monitoring device is provided with a hidden camera fixed at the tail of a car, and a monitor displaying the situation covered by the hidden camera behind the car. But, for large vehicles, they are always not installed with such a backing-up monitoring device, posing insecure backing-up as the condition behind them can not be totally realized or observed by the drivers; or, their tails are installed with a radar to detect the condition behind them while backing up. Usually, a warning alarm is to sound when the radar detects that a car is approaching an object or an obstacle within a certain distance, telling the driver to cautiously move. However, although the warning sound can remind a driver to drive cautiously, it can not tell the driver the actual situation and position of the obstacle, still possible to cause an accident.

### SUMMARY OF THE INVENTION

The objective of this invention is to offer a monitoring device for a driver to see clearly the condition behind a vehicle while backing up.

The main characteristics of the invention are a main body, an emitting device, a transmitting device, a receiving device and a displaying device.

The main body is formed similarly as a hollow shell, pivotally or fixedly plugged in a car, and provided with a power source connector set at its one side and a lens connected to the other side. The lens is an infrared one or a wide-angle one, employed to shoot images behind a car, and provided with a transparent protecting cover covered on its front to prevent it from broken by an external object.

The emitting device is connected with the lens to transmit images shot by the lens to other components.

The transmitting device is connected with the emitting device, transmitting by wire or wirelessly the images coming from the emitting device to the receiving device. The wireless transmission is preferably based on Bluetooth.

The receiving device is connected with the transmitting device to transmit the images coming from the emitting device to the displaying device.

The displaying device is connected with the transmitting means, able to be a screen or a cell phone. The screen is installed in a car to display images shot by the lens by wire, so that the driver can see clearly the situation behind the car. As for the cell phone, it can also receive and display images transmitted from the receiving device by means of Bluetooth wireless transmission.

### BRIEF DESCRIPTION OF DRAWINGS

This invention is better understood by referring to the accompanying drawings, wherein:

FIG. 1 is a top view of a preferred embodiment of a motor backing-up monitoring device in the present invention;

FIG. 2 is a side view of a car to be installed with the motor backing-up monitoring device in the present invention.

FIG. 3 is an upper view of a second preferred embodiment of a motor backing-up monitoring device in the present invention

### DETAILED DESCRIPTION OF THE PREFERRED EMBODIMENT

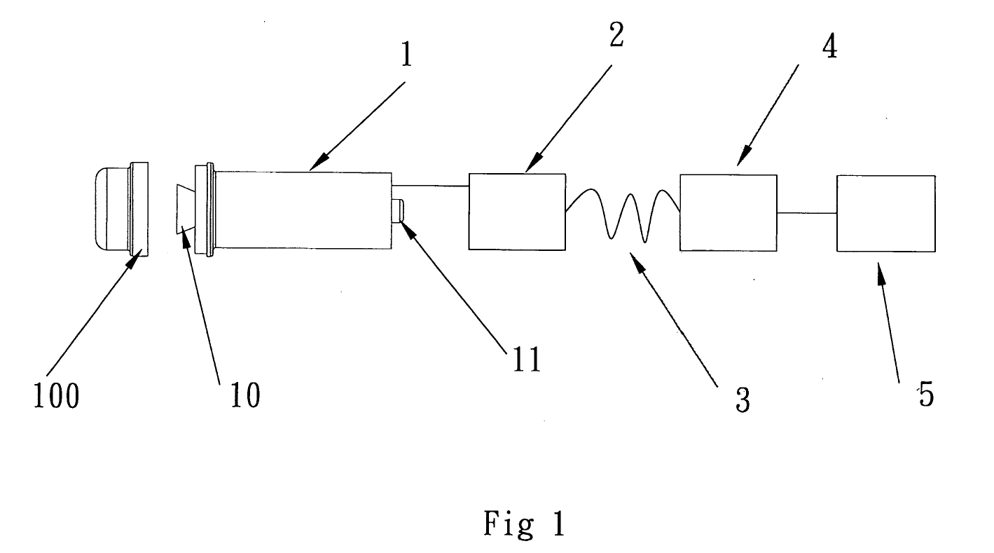

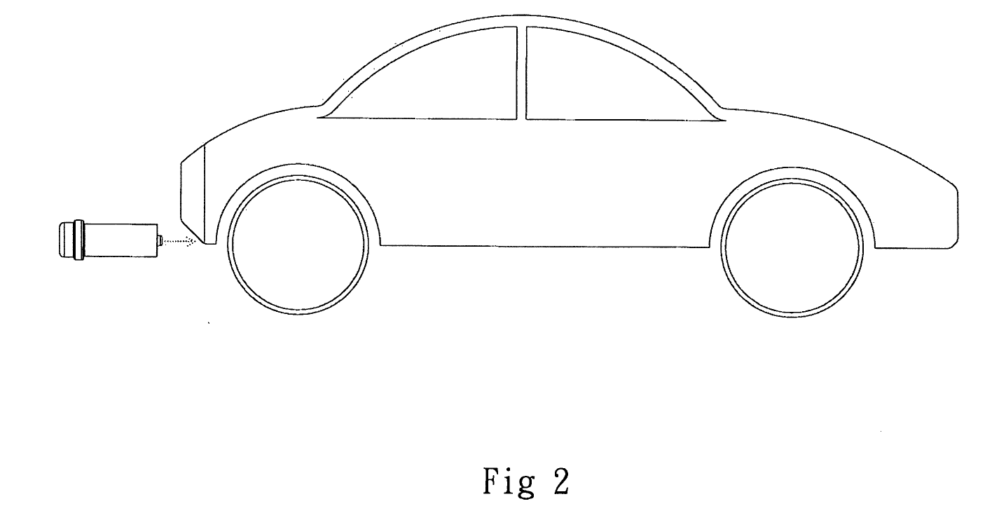

As shown in FIGS. 1 and 2, a preferred embodiment of a motor backing-up monitoring device in the present invention includes a main body 1, an emitting device 2, a transmitting means 3, a receiving device 4 and a displaying device 5.

The main body 1 is formed similarly as a hollow shell, pivotally or fixedly plugged in a car, and provided with a power source connector 11 set at its one side and a lens 10 connected to the other side. The lens 10 is a infrared one or a wide-angle one, employed to shoot images behind a car, and provided with a transparent protecting cover 100 covered on its front to prevent it from broken by external object.

The emitting device 2 is connected with the lens 10 to transmit images shot by the lens 10 to other components.

The transmitting device 3 is connected with the emitting device 2, transmitting by wire or wirelessly the images coming from the emitting device 2 to the receiving device 4. The wireless transmission is preferably based on Bluetooth.

The receiving device 4 is connected with the transmitting device 3 to transmit the images coming from the emitting device 2 to the displaying device 5.

The displaying device 5 is connected with the transmitting device 3, able to be a screen or a cell phone. The screen is installed in a car to display images shot by the lens 10 by wire, so that the driver can see clearly the situation behind the car. As for the cell phone, it can also receive and display images transmitted from the receiving device 4 by means of the Bluetooth wireless transmission.

In using, when a vehicle is shifted into a reverse gear, the power source connector 11 of the main body 1 is to be electrified to initiate all related components to work. By the time, the lens 10 of the main body 1 can immediately start shooting images, and successively transmit the images to the emitting device 2, the transmitting device 3, the receiving device 4 and the displaying device 5 in order. If the transmitting device 3 is based on wire, the images are to be transmitted to the screen on a car; and, if the transmitting device 3 is based on Bluetooth wireless transmission, the images are to be transmitted to a cell phone. Clearly seeing the condition behind a vehicle via the screen or the cell phone, the driver can easily and securely back up the vehicle.

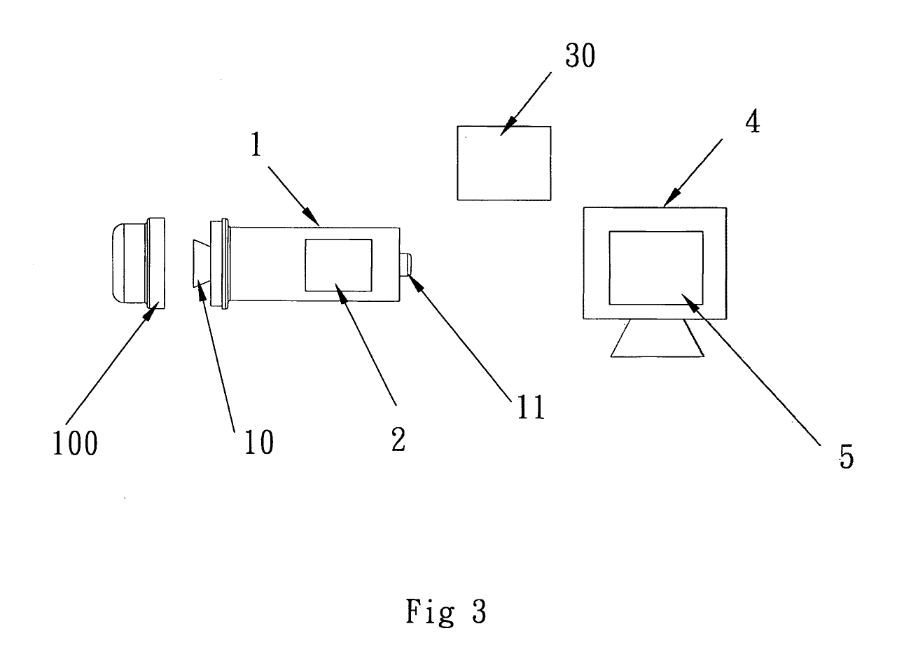

Next, FIG. 3 shows a second embodiment of a motor backing-up monitoring device in the present invention, including a main body 1, an emitting device 2, a transmitting device 3, a receiving device 4 and a displaying device 5, having almost the same components as the first one. The different point is that the emitting device 2 is positioned in the main body 1 in an equivalent condition. So the emitting device 2 sends images shot by the lens 10 via an wireless transmitter 30 such as Bluetooth transmission as an equivalence of the transmitting device 3 to the receiving device 4 where the displaying device is positioned in. Then the images are displayed on the screen of the displaying device 5 so a driver can look at the screen to check if there is any obstacle behind his vehicle or the environmental condition around, boosting safety in backing up his vehicle and avoiding potential accidents.

While the preferred embodiment of the invention has been described above, it will be recognized and understood that various modifications may be made therein and the appended claims are intended to cover all such modifications that may fall within the spirit and scope of the invention.

What is claimed is:

1. A motor backing-up monitoring device comprising:
a main body formed as a hollow shell and pivotally or fixedly plugged in a car, said main body provided with a power source connector set at its one side and a lens connected to its other side;
an emitting device connected with said lens to transmit images shot by said lens to other components;
a transmitting device connected with said emitting device and used to transmit by wire or wirelessly said images coming from said emitting device to other components;
a receiving device connected with said transmitting means to transmit said images coming from said emitting device to other components; and
a displaying device connected with said transmitting means to display said images coming from said receiving device.

2. The motor backing-up monitoring device as claimed in claim 1, wherein said lens is a wide-angle one.

3. The motor backing-up monitoring device as claimed in claim 1, wherein said lens is an infrared one.

4. The motor backing-up monitoring device as claimed in claim 1, wherein said lens is covered by transparent protecting cover.

5. The motor backing-up monitoring device as claimed in claim 1, wherein said transmitting means is based on wireless transmission.

6. The motor backing-up monitoring device as claimed in claim 5, wherein said wireless transmission is based on Bluetooth wireless transmission.

7. The motor backing-up monitoring device as claimed in claim 1, wherein said transmitting device is based on wire.

8. The motor backing-up monitoring device as claimed in claim 1, wherein said displaying device is a screen.

9. The motor backing-up monitoring device as claimed in claim 1, wherein said displaying device is a cell phone.
